(19) United States
(12) Patent Application Publication
(10) Pub. No.: US 2021/0302197 A1
(43) Pub. Date: Sep. 30, 2021

(54) ABNORMALITY DETECTION APPARATUS AND ABNORMALITY DETECTION METHOD

(71) Applicant: HITACHI, LTD., Tokyo (JP)

(72) Inventors: Yohei KAWAGUCHI, Tokyo (JP); Kaori SUEFUSA, Tokyo (JP)

(73) Assignee: HITACHI, LTD., Tokyo (JP)

(21) Appl. No.: 17/188,001

(22) Filed: Mar. 1, 2021

(30) Foreign Application Priority Data
Mar. 25, 2020 (JP) 2020-054833

(51) Int. Cl. G01D 3/08; G05B 23/02; G07C 3/08; G06K 9/62

(52) U.S. Cl. CPC G01D 3/08; G05B 23/0283; G05B 2223/06; G06K 9/6232; G07C 3/08

(57) ABSTRACT

An abnormality detection apparatus is a device for detecting an abnormality of an object, and detects the abnormality of the object by performing predetermined processing on second signals in a predetermined region among first signals derived from vibration acquired from the object.

### BACKGROUND OF THE INVENTION

### 1. Field of the Invention

The present invention relates to an abnormality detection apparatus and an abnormality detection method.

### 2. Description of the Related Art

In general, a state such as an abnormality or a sign of failure of equipment often appears as a sound emitted by the equipment, so it is of great interest to detect an abnormal sound on the basis of operating sound of the equipment. However, in a case where a feature value of a normal operating sound is accompanied by a complicated temporal change, there is a high possibility that an abnormal sound is not correctly detected. It is therefore required to detect an abnormal sound with high accuracy without any mistaken diagnosis even in a case where a feature value of a normal operating sound is accompanied by a complicated temporal change.

JP 2018-160093 A discloses a technology “comprising an arithmetic device that executes processing of learning a predictive model that predicts a behavior of a monitoring target device based on operational data on the monitoring target device, processing of adjusting an anomaly score such that the anomaly score for operational data under normal operation falls within a predetermined range, the anomaly score being based on a deviation of the operational data acquired from the monitoring target device from a prediction result obtained by the predictive model, processing of detecting an anomaly or a sign of an anomaly based on the adjusted anomaly score, and processing of displaying information on at least one of the anomaly score and a result of the detection on an output device”.

### SUMMARY OF THE INVENTION

In JP 2018-160093 A, a time series of future operational data is predicted from a time series of operation data from past to present, and an abnormality score is calculated on the basis of a cumulative error between an observed value and a prediction value. If it is possible to input a time series of a feature value calculated for an operating sound in JP 2018-160093 A, it will be possible to detect an abnormal sound of the equipment. However, this description does not state that JP 2018-160093 A can be applied to detection of an abnormal operating sound (abnormal sound) of equipment, but is merely an assumption.

However, even if the assumption described above holds, in a case where a normal operating sound (normal sound) shows an unexpected temporal change in feature value as in a solenoid valve, a sliding device, an industrial robot, or the like, it becomes overly difficult to predict a future sound, and the magnitude of the abnormality score fails to correspond to whether the machine is normal or abnormal. Thus, the accuracy of abnormal sound detection decreases.

The present invention has been made in view of the above problem, and is aimed at providing an abnormality detection apparatus and an abnormality detection method capable of detecting an abnormality of an object on the basis of a signal derived from vibration of the object.

In order to solve the above problem, the abnormality detection apparatus according to one aspect of the present invention is an abnormality detection apparatus that detects an abnormality of an object, in which an abnormality of the object is detected by performing predetermined processing on second signals in a predetermined region among first signals derived from vibration acquired from the object.

According to the present invention, the abnormality of the object can be detected on the basis of the second signals in the predetermined region among the first signals derived from the vibration of the object.

### BRIEF DESCRIPTION OF THE DRAWINGS

FIG. 1 is an explanatory diagram illustrating an overall outline of the present embodiment;

FIG. 2 is a hardware and software configuration diagram of an abnormal noise detection device;

FIG. 3 is a processing block diagram at the time of learning a normal model;

FIG. 4 is a processing block diagram at the time of detecting an abnormality (at the time of detecting an abnormal noise);

FIG. 5 is a processing block diagram at the time of learning a normal model according to a second embodiment;

FIG. 6 is a processing block diagram at the time of detecting an abnormality;

FIG. 7 is a processing block diagram at the time of learning a normal model according to a third embodiment; and

FIG. 8 is a processing block diagram at the time of detecting an abnormality.

### DESCRIPTION OF THE PREFERRED EMBODIMENTS

Embodiments of the present invention will be described below with reference to the drawings. An abnormal noise detection device according to this embodiment can determine whether an abnormality has occurred in an object on the basis of signals derived from vibration generated by the object. The signals derived from the vibration include vibration signals and sound signals. Changing a sensor terminal used in the present embodiment from a microphone to an acceleration sensor or a displacement sensor allows the present embodiment to be used to detect an abnormality from vibration signals.

The object is, for example, factory equipment or a household electric appliance whose normal sound can change unexpectedly, such as a solenoid valve, a sliding device, or a robot. However, the object is not limited to a machine or an electrical appliance. The present embodiment can be applied to any object so long as the object generates vibration or sound that can change unexpectedly, and an abnormality can be detect on the basis of the vibration or sound. Such an object may be, for example, a human being, a car, or a door. For example, when daily life noise of human beings (speaking voices, footsteps, breath sounds, and the like), car sounds, gunshots, explosion sounds, and other sounds from surrounding environment have been learned, the present embodiment can also be used to detect an occurrence of an abnormal security situation.

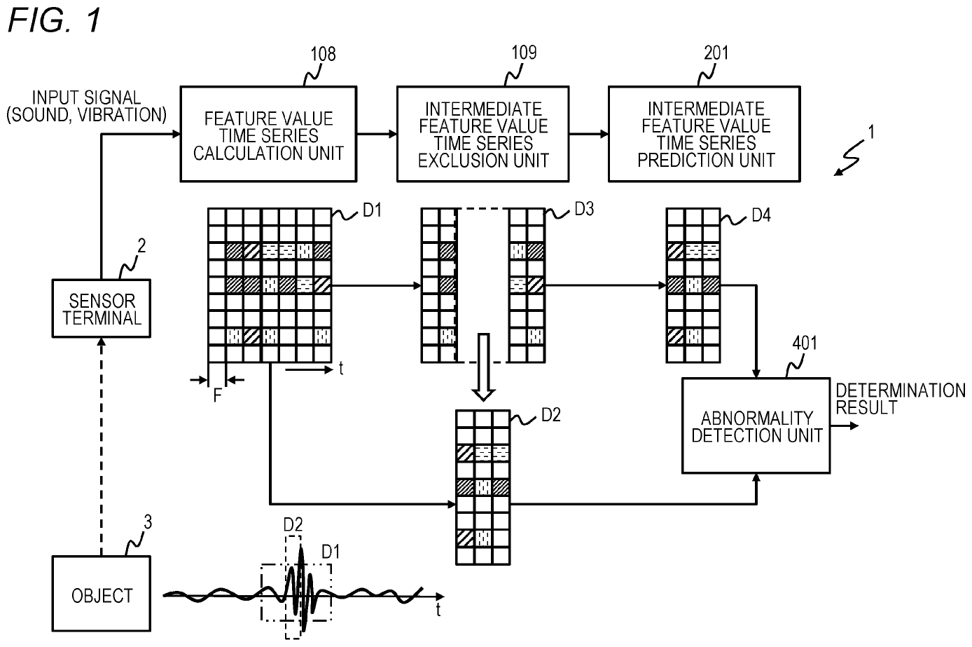

As illustrated in FIG. 1, in the present embodiment, an abnormality of an object 3 is detected by using signals D2 in an intermediate portion on a time axis among first signals D1 derived from vibration of the object 3. In the present embodiment, signals D3 that are located front and rear of the intermediate portion (front and rear on the time axis) are not used, and this improves the accuracy of abnormality detection.

To give one example of an abnormal noise detection device 1 of the present embodiment, the abnormal noise detection device 1 includes a feature value time series calculation unit 108, an intermediate feature value time series exclusion unit 109, an intermediate feature value time series prediction unit 201, and an abnormality detection unit 401. The feature value time series calculation unit 108 calculates a feature value time series D1 of an input signal. The intermediate feature value time series exclusion unit 109 calculates a feature value time series D3 (hereinafter referred to as a post-deletion feature value time series D3) obtained by removing a plurality of frames D2 (hereinafter referred to as an intermediate feature value time series D2) in an intermediate time period from the feature value time series D1. The intermediate feature value time series prediction unit 201 learns, by using the post-deletion feature value time series D3 as an input, a mapping that predicts the intermediate feature value time series D2, and outputs an intermediate feature value time series prediction value D4 (hereinafter referred to as a predicted intermediate feature value time series D4). The abnormality detection unit 401 detects an abnormality on the basis of an error between the intermediate feature value time series D2 and the predicted intermediate feature value time series D4.

According to the present embodiment, the post-deletion feature value time series D3 is constituted by feature quantities in a time period in the front and a time period in the rear in the feature value time series D1. This allows the prediction D4 of the intermediate feature value time series to be obtained even in a case where a normal sound shows an unexpected temporal change in feature value.

Thus, the abnormal noise detection device 1 of the present embodiment can detect an abnormality on the basis of the error between the intermediate feature value time series D2 and the predicted intermediate feature value time series D4. Since the abnormal noise detection device 1 of the present embodiment is just required to predict the intermediate feature value time series D4, the number of parameters can be relatively reduced as compared with an autoencoder for the same input. Thus, the abnormal noise detection device 1 of the present embodiment can easily find optimum parameters during learning. In addition, since the input and the output are different in the abnormal noise detection device 1 of the present embodiment, it is possible to avoid an identity mapping as a result of learning.

JP 2018-160093 A described above also discloses a method of calculating an abnormality score on the basis of a restoration error when an autoencoder in which a time series of operational data from past to present has been input restores the time series to the same state as the input time series. However, in an autoencoder, in a case where a bottleneck layer is too small, restoration becomes overly difficult, and the magnitude of the abnormality score fails to correspond to whether the machine is normal or abnormal.

On the other hand, in a case where the bottleneck layer is too large, the number of parameters increases, and this makes it difficult to find the optimum parameters during learning. In addition, the autoencoder learns so as to receive an input of a vector of a normal sample of learning data and output the same vector as the input vector. As a result of the learning, there is a possibility that the autoencoder becomes an identity mapping in which not just normal samples but also abnormal samples can be completely restored with zero error. In that case, the magnitude of the abnormality score fails to correspond to whether the machine is normal or abnormal, and abnormalities fails to be detected. In this way, tuning of a bottleneck layer is difficult. In addition, in a case where a normal sound shows an unexpected temporal change in feature value, it becomes overly difficult to restore the front-most and rear-most in the time series as in the case of future prediction, and the magnitude of the abnormality score fails to correspond to whether the machine is normal or abnormal. Thus, the accuracy of abnormal sound detection decreases.

On the other hand, as described above, the abnormal noise detection device 1 of the present embodiment can relatively reduce the number of parameters as compared with an autoencoder, and can easily find the optimum parameters during learning. In addition, the abnormal noise detection device 1 of the present embodiment can avoid becoming an identity mapping as a result of learning, and a reliability is improved.

### First Embodiment

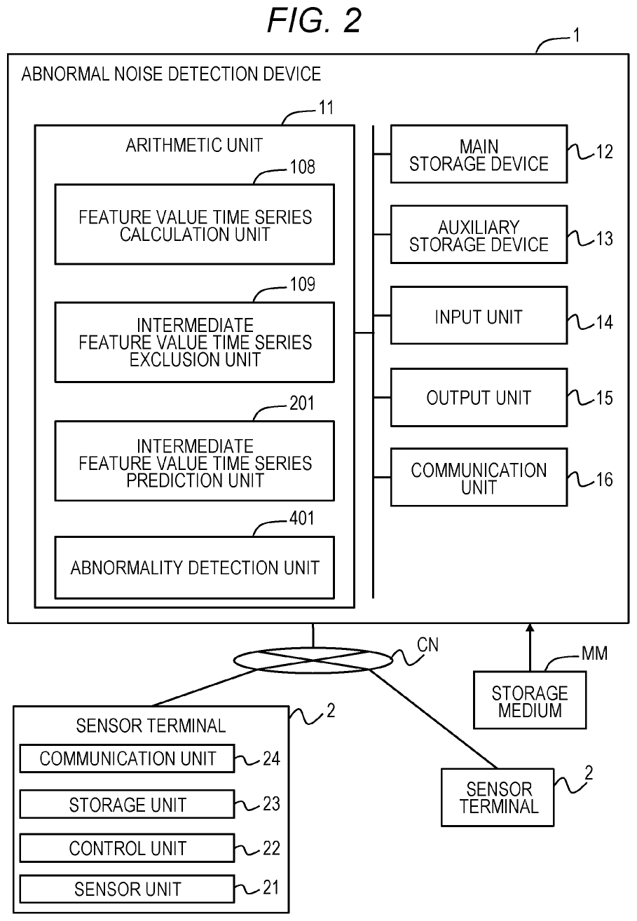

A first embodiment will be described with reference to FIGS. 1 to 4. FIG. 1 is an explanatory diagram illustrating an overall outline of the present embodiment. An abnormality detection apparatus 1 illustrated in FIG. 2 includes a sensor terminal 2 that detects and records a sound generated by an object 3, and an abnormal noise detection device 1. The abnormal noise detection device 1 includes signal processing units 108, 109, 201, and 401 that process sound data (sound signals) recorded by the sensor terminal 2. Details of the signal processing units will be described later.

The object 3 in the present embodiment is an object whose normal sound is not constant but changes unexpectedly or abruptly. Examples of the object 3 as described above include, for example, a control valve that repeatedly opens and closes such as a solenoid valve, an air valve, or a hydraulic valve, a robot that drives an arm or the like with a predetermined operation, and a sliding device that repeatedly accelerates and decelerates.

The sensor terminal 2 is configured as, for example, a portable recording terminal. A configuration example of the sensor terminal 2 will be described later. A sound of the object 3 is recorded by a user grasping the sensor terminal 2 and moving. The recorded data is transmitted from the sensor terminal 2 to the abnormal noise detection device 1. The sensor terminal 2 and the abnormal noise detection device 1 may be integrated. For example, the abnormal noise detection device 1 having a recording function may be configured as a portable device. In this case, the sensor terminal 2 becomes unnecessary.

The feature value time series calculation unit 108 calculates a feature value time series D1 from the sound data from the object 3 detected by the sensor terminal 2. The intermediate feature value time series exclusion unit 109 calculates a post-deletion feature value time series D3 by excluding an intermediate feature value time series D2 in a predetermined region from the feature value time series D1.

Here, as illustrated in FIG. 1, the feature value time series D1 generated from the sound of the object 3 is a spectrogram of the input sound showing time on the horizontal axis and frequency on the vertical axis, and is constituted by a plurality of frames F.

An intermediate feature value time series prediction unit 201 predicts the removed intermediate feature value time series on the basis of the post-deletion feature value time series D3, and outputs an intermediate feature value time series D4 obtained as a result of the prediction. The abnormality detection unit 401 determines whether there is an abnormality in the sound of the object 3, that is, whether an abnormality has occurred in the object 3, by comparing the intermediate feature value time series D2 removed from the original feature value time series D1 with the intermediate feature value time series D4 predicted from the post-deletion feature value time series D3, and outputs a result of the determination.

A configuration example of the abnormal noise detection device 1 will be described with reference to FIG. 2. The abnormal noise detection device 1 includes, for example, an arithmetic unit 11, a main storage device 12, an auxiliary storage device 13, an input unit 14, an output unit 15, and a communication unit 16.

The arithmetic unit 11 includes one or a plurality of microprocessors, and reads a predetermined computer program stored in the auxiliary storage device 13 into the main storage device 12 and executes the computer program, thereby implementing functions such as the feature value time series calculation unit 108, the intermediate feature value time series exclusion unit 109, the intermediate feature value time series prediction unit 201, and the abnormality detection unit 401 as described in FIG. 1. Functions other than the functions 108, 109, 201, and 401 illustrated in FIG. 2 implemented by the arithmetic unit 11 will be described later.

The input unit 14 can include, for example, a keyboard, a touch panel, or a pointing device, and receives an input from a user who is using the abnormal noise detection device 1. The output unit 15 can include, for example, a display, a speaker, or a printer, and provides information to the user.

The communication unit 16 communicates with the sensor terminal 2 via a communication network CN. The communication unit 16 can also communicate with other computers (not illustrated).

A storage medium MM is, for example, a storage medium such as a flash memory or a hard disk that transfers a computer program or data to the abnormal noise detection device 1 for storage, or reads and stores a computer program or data from the abnormal noise detection device 1. The storage medium MM may be directly connected to the abnormal noise detection device 1, or may be connected to the abnormal noise detection device 1 via the communication network CN.

The configuration of the sensor terminal 2 will be described. The sensor terminal 2 includes, for example, a sensor unit 21, a control unit 22, a storage unit 23, and a communication unit 24.

The sensor unit 21 is a microphone that detects a sound of the object 3. Thus, in the following, the sensor unit 21 may be referred to as a microphone 21. Sound data detected by the sensor unit 21 is stored in the storage unit 23. The control unit 22 that controls the sensor terminal 2 transmits the sound data stored in the storage unit 23 to the abnormal noise detection device 1.

Changing the sensor unit 21 from a microphone to an acceleration sensor or the like allows the sensor terminal 2 to detect vibration of the object 3. Then, the abnormal noise detection device 1 can detect an abnormality on the basis of the vibration of the object 3. In this case, the abnormal noise detection device 1 can also be called the abnormality detection apparatus 1.

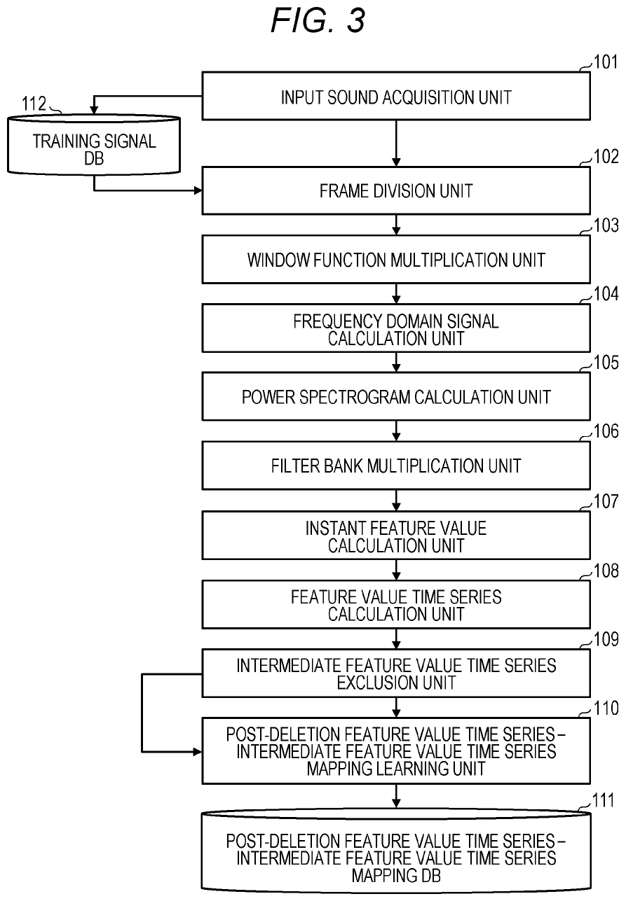

FIG. 3 is a processing block diagram at the time of learning a normal model related to the abnormal noise detection device 1. In the drawing, a database is abbreviated as DB. An input sound acquisition unit 101 converts an analog input signal input from the microphone 21 into a digital input signal by an analog-to-digital (A/D) converter, and stores the digital input signal in a training digital input signal database 112.

The frame division unit 102 divides a digital input signal, which has been extracted from the training digital input signal database 112, for each specified number of time points (hereinafter referred to as a frame size), and outputs a frame signal. Frames may overlap each other.

A window function multiplication unit 103 multiplies an input frame signal by a window function, and outputs a window function multiplication signal. For the window function, for example, a Hanning window is used.

A frequency domain signal calculation unit 104 performs a short-time Fourier transform on an input signal after window function multiplication, and outputs a frequency domain signal. The frequency domain signal is a set of M complex numbers, in which each of (N/2+1)=M frequency bins, where N is the frame size, corresponds to one complex number. The frequency domain signal calculation unit 104 may use a frequency transform method such as constant-Q transform (CQT) instead of the short-time Fourier transform.

A power spectrogram calculation unit 105 outputs, on the basis of an input frequency domain signal, its power spectrogram. A filter bank multiplication unit 106 multiplies an input power spectrogram by a mel filter bank, and outputs a mel power spectrogram. The filter bank multiplication unit 106 may use a filter bank such as a ⅓ octave-band filter instead of the mel filter bank.

An instant feature value calculation unit 107 applies a logarithm to an input mel power spectrogram, and outputs a log-mel power spectrogram. Instead of the log-mel power spectrogram, a mel frequency cepstrum coefficient (MFCC) may be calculated. In that case, instead of the filter bank multiplication unit 106 and the instant feature value calculation unit 107, a logarithmic value of the power spectrogram is calculated, a filter bank is multiplied, a discrete cosine transform is performed, and an MFCC is output.

The feature value time series calculation unit 108 connects adjacent L frames to an input log-mel power spectrogram or the MFCC, and outputs a feature value time series D1. Instead of the log-mel power spectrogram or the MFCC, a time series (delta) of their time difference or time derivative may be input, adjacent L frames may be connected, and thus a feature value time series D1 may be output.

Alternatively, a time series (delta-delta) of a time difference or a time derivative of a time series of a time difference or a time derivative may be input, adjacent L frames may be connected, and thus a feature value time series D1 may be output. Moreover, a combination of any of these may be selected and connected in a feature value axis direction, adjacent L frames may be connected, and thus a feature value time series D1 may be output.

The intermediate feature value time series exclusion unit 109 removes an intermediate feature value time series D2, which is a plurality of frames (a plurality of frame in a predetermined region) in an intermediate time period in an input feature value time series D1, from the feature value time series D1, and outputs a post-deletion feature value time series D3.

Here, as the intermediate feature value time series D2, K adjacent frames that are exactly in the center of the feature value time series D1 may be selected, or K adjacent frames that are displaced toward the front or rear from the center may be selected. Alternatively, C (two or more) clusters each including K frames may be deleted. In that case, of the L frames, CK frames are deleted and (L−CK) frames remain as an input feature value.

In any case, in the present embodiment, frames in the front and rear are retained as an input feature value D3. This enables prediction of an intermediate feature value time series (D4) even in a case where a normal sound shows an unexpected temporal change in feature value. An abnormality can be detected even in a case where K=1 holds. However, in a case where K=1 holds, there is a high possibility that the intermediate feature value time series can be interpolated with high accuracy by using just information of the frames in the front and rear, regardless of whether the object 3 is normal or abnormal.

On the other hand, in a case where K is set to 2 or more, it is difficult to predict the intermediate feature value time series just from the frames in the front and rear as compared with the case where K=1 holds. Thus, the prediction value of the intermediate feature value time series (D4) strongly depends on a distribution of learned feature quantities in a normal state.

Thus, in a case where the object 3 is normal, both the prediction value (D4) and a true value (D2) of the intermediate feature value time series conform to the distribution of learned feature quantities in a normal state, and an error between the prediction value (D4) and the true value (D2) decreases.

On the other hand, in a case where the object 3 is abnormal, the prediction value (D4) of the intermediate feature value time series conforms to the distribution of learned feature quantities in a normal state. However, the true value (D2) of the intermediate feature value time series does not conform to the distribution of feature quantities in a normal state, and the error between the prediction value (D4) and the true value (D2) increases. Thus, the accuracy of abnormality detection is higher in a case where K is 2 or more than in a case where K=1 holds. It is therefore desirable to set K to 2 or more.

A post-deletion feature value time series-intermediate feature value time series mapping learning unit 110 learns a mapping that predicts an intermediate feature value time series D2 from an input post-deletion feature value time series D3 by using a set of pairs of a post-deletion feature value time series D3 and an intermediate feature value time series D2 as training data. Then, the mapping (hereinafter referred to as a post-deletion feature value time series-intermediate feature value time series mapping) is saved in a post-deletion feature value time series-intermediate feature value time series mapping database 111.

For the post-deletion feature value time series-intermediate feature value time series mapping, for example, linear regression, ridge regression, Lasso regression, partial least squares (PLS) regression, support vector regression, a neural network, a variational neural network, a Gaussian process, a deep Gaussian process, a long short-term memory (LSTM), a Bidirectional LSTM, or a gated recurrent unit (GRU) may be used.

For example, in a case where a neural network is used, an optimization algorithm such as stochastic gradient descent (SGD), momentum SGD, an adaptive gradient algorithm (AdaGrad), root mean squared propagation (RMSprop), AdaDelta, or adaptive moment estimation (Adam) is used to optimize an internal parameter so as to decrease a norm of a difference (prediction error vector) between an intermediate feature value time series D4 predicted when a post-deletion feature value time series is input and an observed intermediate feature value time series D2. The norm of the prediction error vector may be an appropriate norm such as an L1 norm, an L2 norm, or an L1/2 norm.

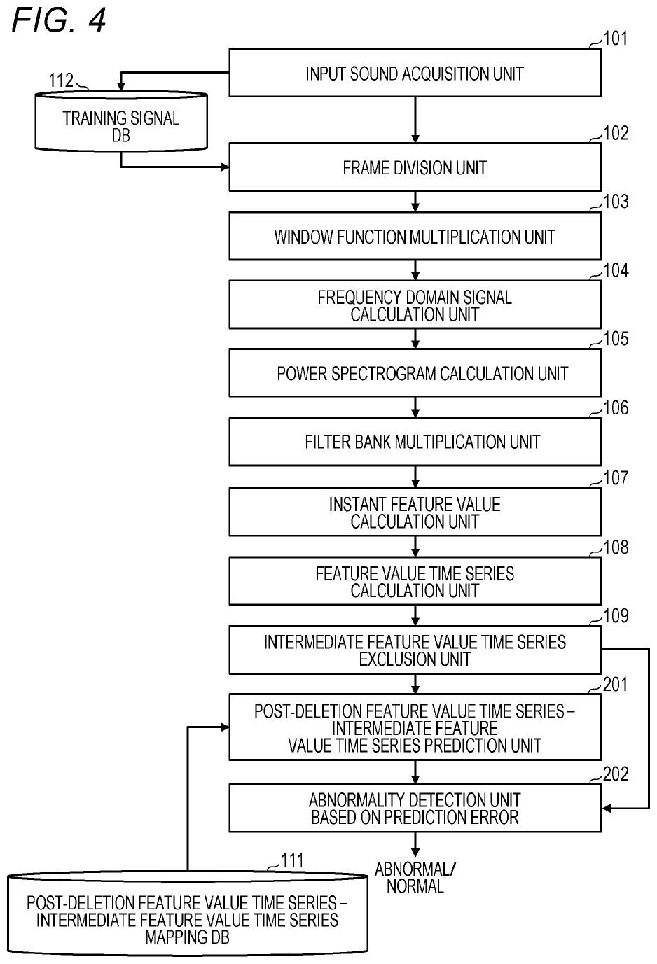

FIG. 4 is a processing block diagram at the time of inferring abnormality detection. The processing from the input sound acquisition unit 101 to the intermediate feature value time series exclusion unit 109 has been described above in FIG. 3, and the description thereof will be omitted.

On the basis of a post-deletion feature value time series-intermediate feature value time series mapping read from the post-deletion feature value time series-intermediate feature value time series mapping database 111 and a post-deletion feature value time series D3 input from the intermediate feature value time series exclusion unit 109, the post-deletion feature value time series-intermediate feature value time series prediction unit 201 predicts an intermediate feature value time series D2 missing from an original feature value time series D1, and outputs an intermediate feature value time series D4 obtained by the prediction.

An abnormality detection unit 202 detects whether an abnormality has occurred in the object 3 (whether the operating sound of the object 3 is normal) on the basis of a prediction error.

The abnormality detection unit 202 calculates, as a prediction error, a difference between the observed intermediate feature value time series D2 input from the intermediate feature value time series exclusion unit 109 and the intermediate feature value time series D4 predicted by the post-deletion feature value time series-intermediate feature value time series prediction unit 201 (this difference is called a prediction error vector). The abnormality detection unit 202 determines that the object 3 is abnormal if the norm of the prediction error vector is larger than a certain positive threshold value, and determines that the object 3 is normal if the norm is smaller than the threshold value.

Instead of reducing the number of dimensions of the post-deletion feature value time series D3 by performing deletion, it is also possible to fill the deleted dimensions with zeros, appropriate constants, or random numbers. In a case where random numbers are used and mini-batch learning is performed for learning, different random numbers are generated for each mini-batch.

In a case where the feature value time series D1 is constant and remains almost the same in the time axis direction, the intermediate feature value time series can be easily predicted. In a case where there is no temporal change in the feature value time series D1, the intermediate feature value time series can be completely restored with zero error not just for normal sound samples but also for abnormal sound samples. In this case, the magnitude of the abnormality score fails to correspond to the normal/abnormal state of the object 3, and abnormalities fails to be detected.

It is also conceivable to set the number of deleted frames K to a larger value so that prediction of the intermediate feature value time series (D4) becomes difficult. Increasing the number of deleted frames K is effective to a certain extent, but a sufficient effect fails to be obtained in a case of a strong stationarity.

In the present embodiment, this problem is solved by not just deletion in the time axis direction but also deletion of a specific feature value dimension from the feature value time series D1. The feature value dimension to be deleted is a set of feature value dimensions that are highly dependent on each other in the feature value axis direction. As a result, just dimensions having high independence remain, and it becomes difficult to predict a deletion value using just the feature quantities of that dimensions.

Thus, the prediction value (D4) strongly depends on a distribution of learned feature quantities in a normal state. Thus, in a case where the object 3 is normal, both the prediction value (D4) and a true value (D2) of the intermediate feature value time series conform to the distribution of learned feature quantities in a normal state, and an error between the prediction value (D4) and the true value (D2) decreases. On the other hand, in a case where the object 3 is abnormal, the prediction value (D4) of the intermediate feature value time series conforms to the distribution of learned feature quantities in a normal state, but the true value (D2) of the intermediate feature value time series does not conform to the distribution of feature quantities in a normal state, and the error between the prediction value (D4) and the true value (D2) increases. Thus, abnormality detection works correctly.

The abnormality detection apparatus 1 calculates, for example, mutual information MI (i, j) of each of feature value dimensions i and j for all training samples (sound data) in the training digital input signal database 112, and uses that value in i rows and j columns to calculate an adjacency matrix A={MI (i, j)}_i, j In addition, the abnormality detection apparatus 1 calculates a diagonal matrix D in which a sum of elements in the i-th row of A is expressed in i rows and i columns.

Then, a graph Laplacian L=D−A is calculated. A random walk normalized graph Laplacian L⁻=D\hat{ }{−1} L is calculated. Then, the random walk normalized graph Laplacian L⁻ is decomposed into eigenvalues. The eigenvectors obtained by the eigenvalue decomposition are arranged in ascending order in accordance with the magnitude of the eigenvalues. It is determined whether an absolute value of each dimension element of V eigenvectors corresponding to specified V minimum eigenvalues is greater than or equal to a specified threshold value. Just dimensions in which absolute values of elements are greater than or equal to the threshold value are selected as dimensions to be deleted. The dimensions selected as dimensions to be deleted are a set of feature value dimensions that are highly dependent on each other.

In a case where a log-mel power spectrogram or an MFCC is used, it is possible to take advantage of high dependency between adjacent dimensions and collectively delete all dimensions in which the feature value dimension i is greater than or equal to K_min and less than or equal to K_max on the basis of the K_min and K_max specified in advance.

### Second Embodiment

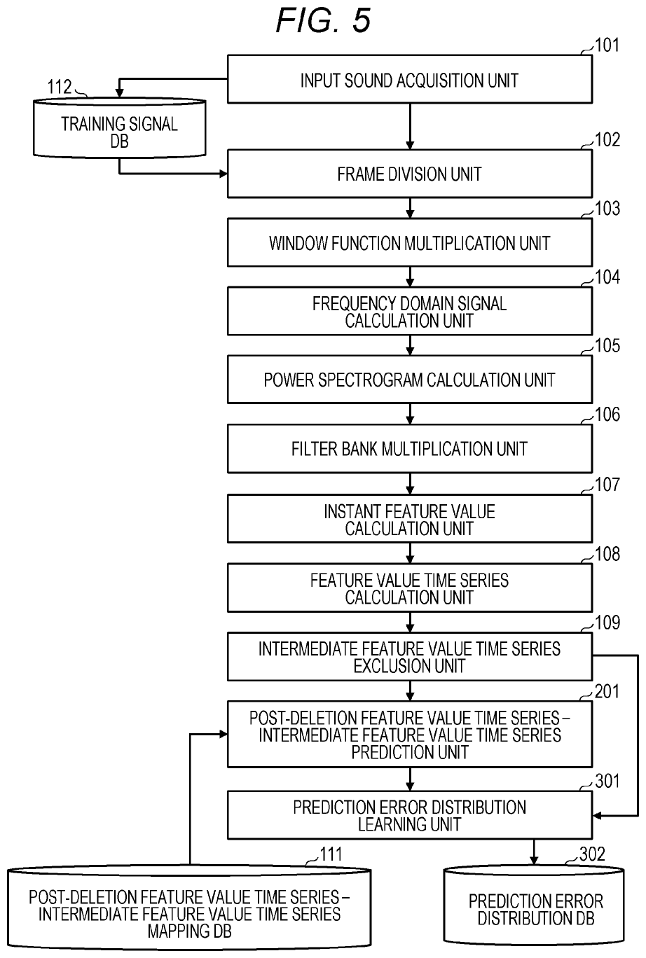

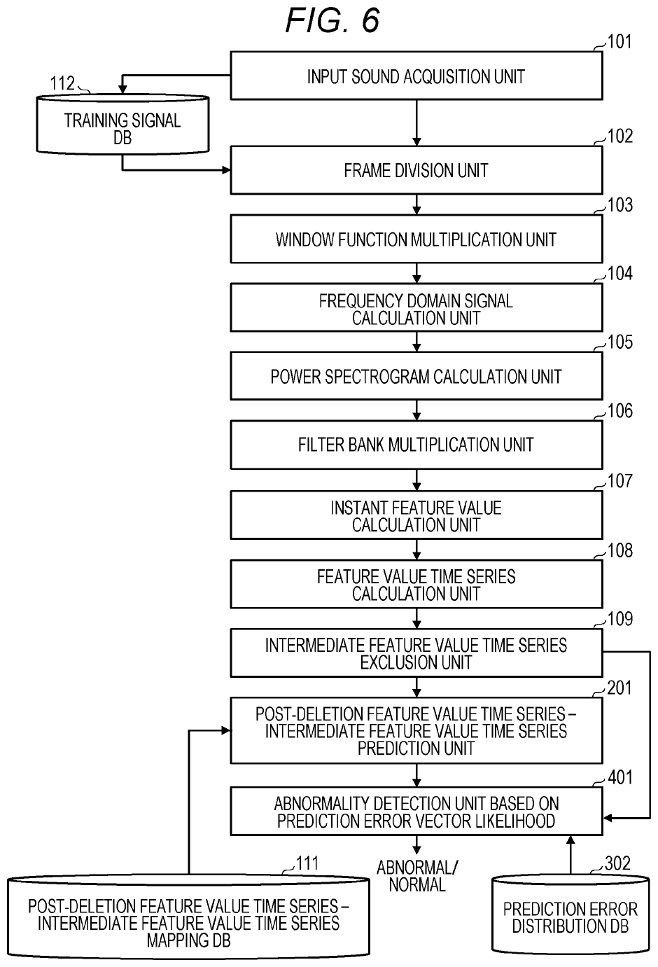

A second embodiment will be described with reference to FIGS. 5 and 6. In each of the following embodiments including the present embodiment, differences from the first embodiment will be mainly described. In the present embodiment, a case is described in which a distribution of prediction error vectors is not an isotropic Gaussian distribution.

The abnormality detection unit 202 based on a prediction error in the first embodiment makes a determination of normality or abnormality on the basis of a norm of a prediction error vector. However, in practice, for example, in a case where prediction errors have different variances depending on the feature value dimension, in a case where prediction errors have a correlation between different feature value dimensions, or in a case where prediction error vectors conform to a more complicated distribution, the distribution of the prediction error vectors is often not an isotropic Gaussian distribution. In this case, the accuracy of abnormality detection may decrease. To cope with this problem, the present embodiment discloses a method in which abnormalities can be detected with high accuracy even in a case where the distribution of the prediction error vectors is not an isotropic Gaussian distribution.

FIG. 5 is a processing block diagram at the time of learning a normal model. Processing from an input sound acquisition unit 101 to an intermediate feature value time series exclusion unit 109 is as described in FIG. 3, and the description thereof will be omitted. A post-deletion feature value time series-intermediate feature value time series prediction unit 201 is as described in FIG. 4, and the description thereof will be omitted.

From a set of an observed intermediate feature value time series D3 and a predicted intermediate feature value time series D4 calculated by a series of processing from a frame division unit 102 to the post-deletion feature value time series-intermediate feature value time series prediction unit 201 for data of each training sample in a training digital input signal database 112, a prediction error distribution learning unit 301 calculates a prediction error vector, which is a difference between the observed intermediate feature value time series D3 and the predicted intermediate feature value time series D4.

Then, on the basis of prediction error vectors for all training samples, a parameter of a distribution they conform to is estimated and stored in a prediction error distribution database 302. As the distribution, for example, a multivariate Gaussian distribution can be used. Using a multivariate Gaussian distribution allows the prediction error vectors to be normalized even in a case where prediction errors have different variances depending on the feature value dimension or in a case where prediction errors have a correlation between different feature value dimensions, and the accuracy of abnormality detection does not decrease.

A parameter of the multivariate Gaussian distribution is defined by one mean vector and one covariance matrix. Thus, the distribution is estimated by calculating sampling statistics from the prediction error vectors for all training samples.

Even in a case where the distribution of the prediction error vectors is a more complicated multimodal distribution, it is possible to suppress a decrease in the accuracy of abnormality detection by using, for example, a mixed Gaussian distribution. Parameters of the mixed Gaussian distribution are a mixing ratio of each Gaussian distribution model, a mean vector of each Gaussian distribution model, and a covariance matrix of each Gaussian distribution model. These parameters of the mixed Gaussian distribution can be estimated from the prediction error vectors for all training samples by using a known method such as an expectation-maximization (EM) algorithm.

FIG. 6 is a processing block diagram at the time of inferring abnormality detection. An abnormality detection unit 401 based on a prediction error vector likelihood calculates a prediction error vector, which is a difference between the observed intermediate feature value time series D3 and the predicted intermediate feature value time series D4. An abnormality detection apparatus 1 uses the parameter of the distribution of the prediction error vectors extracted from the prediction error distribution database 302 to calculate the likelihood that a prediction error vector is generated. The abnormality detection apparatus 1 determines that the state is abnormal if the likelihood is smaller than a certain threshold value, and determines that the state is normal if the likelihood is larger than the threshold value.

The present embodiment having the configuration as described above has effects similar to those of the first embodiment. Moreover, the present embodiment can be used even in a case where the distribution of the prediction error vectors is not an isotropic Gaussian distribution, and this improves usability for a user.

### Third Embodiment

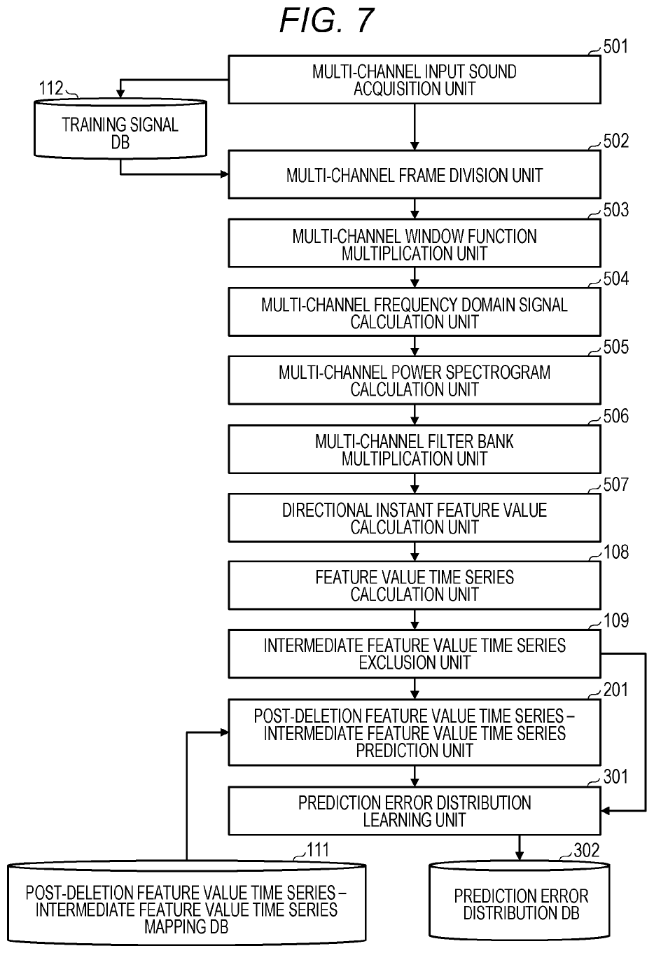

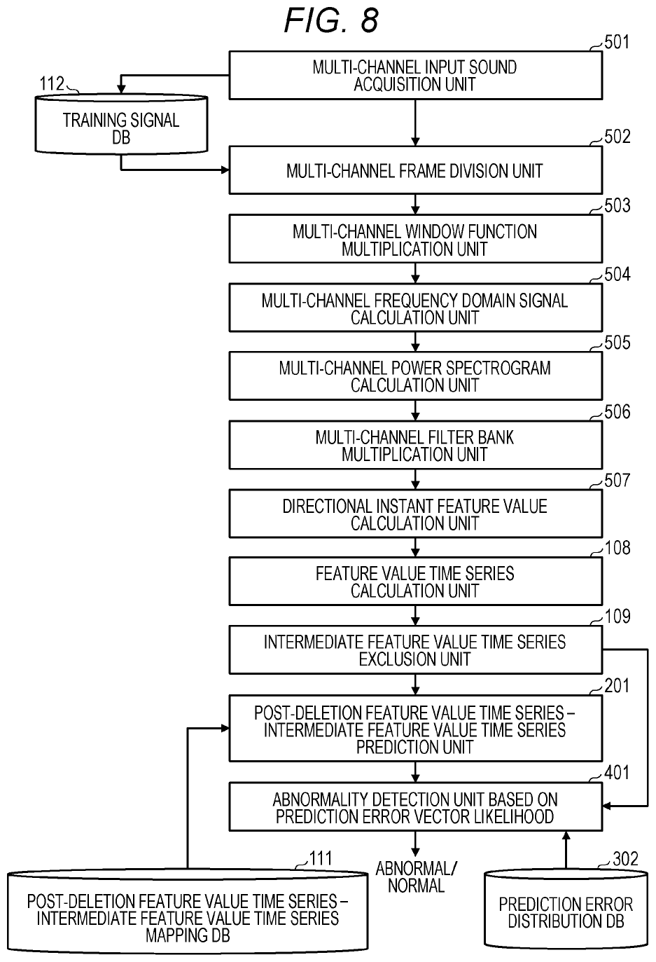

A third embodiment will be described with reference to FIGS. 7 and 8. In the first embodiment, a case where the number of channels is one has been described. However, there are cases where just some of the channels do not work due to, for example, an electrical failure or a wind noise. On the other hand, in a case where the number of channels is two or more, redundancy of a plurality of channels and information regarding the direction from which a sound has arrived can be used to achieve robust abnormality detection for variation between channels.

FIG. 7 is a processing block diagram at the time of learning a normal model. A multi-channel input sound acquisition unit 501, a multi-channel frame division unit 502, a multi-channel window function multiplication unit 503, and a multi-channel frequency domain signal calculation unit 504 are respectively obtained by expanding the input sound acquisition unit 101, the frame division unit 102, the window function multiplication unit 103, and the frequency domain signal calculation unit 104 described in FIG. 3 for the purpose of supporting a plurality of channels.

A multi-channel power spectrogram calculation unit 505 calculates an arrival direction spectrum of a sound in each time period on the basis of a multi-channel frequency domain signal calculated by the multi-channel frequency domain signal calculation unit 504. Then, the multi-channel power spectrogram calculation unit 505 outputs an arrival direction spectrogram in which calculated arrival direction spectra are connected in time series. For the calculation of the arrival direction spectra, for example, a method such as steered response power with the phase transform (SRP-PHAT) or multiple signal classification (MUSIC) can be used.

A directional instant feature value calculation unit 507 calculates a directional instantaneous feature value time series on the basis of a multi-channel mel power spectrogram calculated by a series of processing from the multi-channel input sound acquisition unit 501 to a multi-channel filter bank multiplication unit 506, and an arrival direction spectrogram calculated by an arrival direction feature calculation unit 508.

The directional instant feature value calculation unit 507 connects mel power spectrograms of all channels in the feature value axis direction, and further connects arrival direction spectrograms in the feature value axis direction. Then, the directional instant feature value calculation unit 507 outputs connected feature value time series as a directional instantaneous feature value time series. From this point onward, learning is performed by processing similar to that in the second embodiment.

FIG. 8 is a processing block diagram at the time of inferring abnormality detection. In a similar manner to the processing at the time of learning in FIG. 7, a directional instantaneous feature value time series is calculated, and the processing is similar to that in FIG. 7 except that the calculated directional instantaneous feature value time series is used.

The present embodiment having the configuration as described above has effects similar to those of the first embodiment. Moreover, the present embodiment can be used for a plurality of channels each detecting sound. As a result, even in a case where a trouble occurs in some of the plurality of channels, sounds input from other channels can be used, and reliability is improved. Moreover, the present embodiment uses a plurality of channels, and this allows for calculation of the direction in which a sound arrives, and detection of an abnormality even in a case where sounds input from a plurality of channels change.

The present invention is not limited to the embodiments described above, and includes various modifications. For example, the embodiments described above have been described in detail to describe the present invention in an easy-to-understand manner, and is not necessarily limited to those having all the configurations described. In addition, it is possible to replace a part of the configuration of one embodiment with the configuration of another embodiment, and it is also possible to add the configuration of one embodiment to the configuration of another embodiment. In addition, it is possible to perform, on a part of the configuration of each embodiment, addition, deletion, or replacement with another configuration.

The present invention is also applicable to, for example, the security field. Sounds in an ordinary state in homes, offices, and various facilities can be learned as normal sounds, and unexpected sounds other than normal sounds (e.g., a gunshot, a sound of a falling person or object, a scream, and an alarm) can be detected as abnormal sounds.

Moreover, the present invention also allows for detection of an abnormality from vibration instead of sound. As described above, a vibration sensor (acceleration sensor or the like) may be used as the sensor unit 21.

Moreover, instead of deleting an intermediate feature value time series D3 from a feature value time series D1, it is possible to apply a weight to a calculation result for a predetermined intermediate region in the feature value time series D1.

The above-described configurations, functions, processing units, processing means, and the like may be enabled by hardware in which a part or all of them are designed as, for example, an integrated circuit. In addition, the above-described configurations, functions, and the like may be enabled by software in which a processor interprets and executes a program for implementing each of the functions. Information such as programs, tables, and files for implementing each function can be stored in a memory, a recording device such as a hard disk or a solid state drive (SSD), or a recording medium such as an integrated circuit (IC) card, a secure digital (SD) card, or a digital versatile disc (DVD).

Control lines and information lines indicate what is considered necessary for description, and not all control lines and information lines may be indicated in a product. In practice, it can be considered that almost all configurations are interconnected.

Each component of the present invention can be optionally selected, and an invention having the selected configuration is also included in the present invention. Moreover, the configurations described in the claims can be combined in addition to the combinations specified in the claims.

What is claimed is:

1. An abnormal noise detection device that detects an abnormality of an object,
wherein an abnormality of the object is detected by performing predetermined processing on second signals in a predetermined region among first signals derived from vibration acquired from the object.

2. The abnormal noise detection device according to claim 1, wherein
the predetermined region is a region of a predetermined time period that is centered on a center of a time axis of the first signals and extends frontward and rearward.

3. The abnormal noise detection device according to claim 1, wherein
the predetermined region is a region of a predetermined rate that is centered on a center of an entire time length of the first signals and extends frontward and rearward.

4. The abnormal noise detection device according to claim 1, wherein
the predetermined region includes, in a case where a state of the object changes, either a signal immediately before the change in state or a signal immediately after the change in state.

5. The abnormal noise detection device according to claim 1, wherein
the predetermined processing is processing of restoring, on the basis of third signals obtained by removing the second signals from the first signals, the removed second signals as fourth signals, and comparing the second signals removed from the first signals with the fourth signals.

6. The abnormal noise detection device according to claim 1, wherein
the predetermined processing is processing of weighting the second signals among the first signals.

7. The abnormal noise detection device according to claim 1, wherein
the object generates, as a signal derived from the vibration, a sound signal or a vibration signal that temporally changes with a change in state.

8. The abnormal noise detection device according to claim 1, wherein
the first signals are time series data of feature quantities for each frame.

9. The abnormal noise detection device according to claim 1, comprising:
a feature value time series calculation unit that calculates a feature value time series of input signals derived from vibration acquired from the object as the first signals;
an intermediate feature value time series exclusion unit that calculates third signals that are a post-deletion feature value time series obtained by removing, from the calculated first signals, the second signals that are an intermediate feature value time series existing in the predetermined region;
an intermediate feature value time series mapping prediction unit that uses the third signals as an input to learn a mapping that predicts the second signals, and outputs fourth signals that are a predicted intermediate feature value time series; and
an abnormality detection unit that detects an abnormality of the object on the basis of an error between the second signals and the fourth signals.

10. An abnormality detection method of detecting an abnormality of an object by a computer, the method comprising:
acquiring an input signal derived from vibration acquired from the object;
calculating a feature value time series of the acquired input signal;
calculating a post-deletion feature value time series obtained by removing an intermediate feature value time series from the calculated feature value time series;
learning a mapping that predicts the intermediate feature value time series by using the post-deletion feature value time series as an input, and outputting the predicted intermediate feature value time series; and
detecting an abnormality of the object on the basis of an error between the intermediate feature value time series and the predicted intermediate feature value time series.
